(19) United States
(12) Patent Application Publication
(10) Pub. No.: US 2019/0028236 A1
(43) Pub. Date: Jan. 24, 2019

(54) FEC DRIVEN LINK OPTIMIZATION

(71) Applicants: DAVIDE TONIETTO, OTTAWA (CA); MARC-ANDRE LACROIX, OTTAWA (CA); HENRY WONG, OTTAWA (CA)

(72) Inventors: DAVIDE TONIETTO, OTTAWA (CA); MARC-ANDRE LACROIX, OTTAWA (CA); HENRY WONG, OTTAWA (CA)

(21) Appl. No.: 15/656,888

(22) Filed: Jul. 21, 2017

(51) Int. Cl. H04L 1/00; H04L 12/26

(52) U.S. Cl. CPC H04L 1/0045; H04L 43/0823

(57) ABSTRACT

Methods, systems and computer-readable media for optimizing SerDes system parameters based on a bit error rate detected by a forward error correction unit (FEC). A SerDes receiver receives a data stream over a link and uses a FEC to detect error information in the received data stream. The system tunes and optimizes one or more SerDes system parameters using the detected error information. The system minimizes power consumption by decreasing power supply voltage until a maximum acceptable input error rate threshold is reached. The FEC allows the system to tolerate errors in the input data stream up to the threshold while preventing propagation of these errors in the FEC output data stream.

### FIELD

The present disclosure relates to serializer-deserializers (SerDes). In particular, the present disclosure relates to methods and systems for optimization of system parameters in SerDes.

### BACKGROUND

A serializer-deserializer (SerDes, or SERDES) is a pair of functional blocks used for high-speed communication between two systems, such as two application-specific integrated circuits (ASICs), across a limited input/output link between the two systems. Generally, each system will include at least one SerDes transmitter and at least one SerDes receiver, thereby allowing bidirectional communication, although some such SerDes will use only transmitters on the first system and only receivers on the second system.

A SerDes communicates across the input/output link using a high-speed digital signal. This signal is transmitted by the SerDes transmitter, and the characteristics of the signal are determined by various system parameters set by the SerDes Transmitter and/or receiver. These system parameters may include sampling timing offset; sampling vertical (voltage) offset; amount of gain provided by a continuous time linear equalizer (CTLE); amount of gain provided by a decision feedback equalizer (DFE); power consumption; and potentially others. The settings used for these system parameters by the transmitter and/or receiver affect the various characteristics of the signal received at the other end of the link at the receiver: amplitude, phase, noise, and so forth.

As SerDes data rates have increased with advances in communication technology, signal integrity has become more difficult to maintain across the input/output link. A variety of impairments (ISI, noise, jitter, etc.) can affect the transmission of data over a link, and result in signal-to-noise ratio (SNR) being compromised and errors appearing at the receiver.

Accordingly, newer standards for SerDes recommend the use of Forward Error Correction (FEC) at data rates of 25 Gbps (gigabit per second); at data rates above 25 Gbps, or where PAM4 modulation is used, FEC becomes mandatory. Forward Error Correction is a system for detecting and correcting errors in the coded data stream received by the receiver of a SerDes.

In a typical FEC configuration, a redundancy overhead is added to the payload data at the transmitter side, using a certain coding. The coding allows for errors to be detected and corrected, up to a certain threshold (which depends on the amount and type of coding overhead and type of error pattern).

The rate of received errors is referred to as the Bit Error Rate (BER). The FEC module is capable of correcting a certain number of errors per unit of time, and its efficacy is measured by its Coding Gain. The Coding Gain of the FEC module is calculated as the ratio between the BER of the received coded data before passing through the FEC module, and the BER of the output of the FEC module.

A FEC module with a higher Coding Cain means that the received coded signal can have a lower SNR without disrupting output signal integrity. With high Coding Gain, a significant rate of bit error can appear at the input of the FEC module before errors appear at the FEC module output. Another way to define Coding Gain is the difference in equivalent SNR at the input and output of the FEC module.

Example conventional FEC modules used in wire line communications, the KR4 FEC and KP4 FEC, have respectively 5.8 dB and 7.2 dB of Coding Gain at a BER of 1E-15. This means that these FEC module types can exhibit zero errors at their outputs with BERs on the order of 1E-4 and 1E-5, respectively, at their inputs.

Another concern with SerDes design is that, as signal integrity is reduced and link margins shrink, the fine tuning of system parameters becomes more important in order to optimize link quality and other system characteristics, yet at the same time the sensitivity and narrow link margins of the system makes such tuning more difficult when the link is in use because of the risk of disrupting the integrity of the signal.

Accordingly, SerDes systems presently use two methods for optimization of system parameters: SerDes Calibration, which calibrates the system parameters based on characteristics of the SerDes blocks themselves, and SerDes Adaptation, which monitors the performance of input/output link and adapts the system to characteristics of the link as well as characteristics of the SerDes blocks. These methods can be used in a typical SerDes across a single link to achieve a BER at the receiver (without FEC) of 1E-17 or below.

SerDes Calibration is typically carried out when a link starts up. It is not dependent on the link. It adjusts a variety of system parameters in the circuitry as follows: a quantity (e.g. voltage, current, or phase) is measured via a measuring circuit, such as an analog-to-digital converter (ADC), and action is taken to increase or decrease that quantity until the quantity reaches a target level. The quantities being measured may be, for example, voltage offsets, timing offsets, and/or current. All of these system parameters are calibrated independently from the BER at the receiver. Calibrations are carried out with closed loop state machines that aim to reach a design target for a certain voltage or current. The assumption built into the design of the SerDes is that if all the system parameter re calibrated to the target point, the BER will be minimized.

SerDes Adaptation is typically carried out at link startup time, as well as continuously in the background during link operation while data is being transmitted. SerDes Adaptation depends upon the link itself. It typically involves the optimization of continuous time and discrete time filters that are used to minimize inter-symbol interference (ISO due to channel insertion loss. In more sophisticated systems, SerDes Adaptation may include other system parameters, such as sampling voltage and timing offset, which may different for different channels. SerDes Adaptation typically includes: transmitter Finite Impulse Response (FIR), which is typically carried out only at start up via standard link training protocols; receiver continuous time linear equalization (CTLE), which is typically carried out using eye monitoring metrics; and decision feedback equalization (DFE), which is typically carried out using a least mean square (LMS) algorithm. As temperature, voltage and other environmental conditions vary in time, SerDes Adaptation keeps optimizing the transceiver system parameters in an attempt to maintain signal integrity.

A variety of components and techniques may be used in SerDes Calibration and/or Adaptation. Process, voltage, temperature (PVT) sensors may be used to sense power, voltage, and temperature to calibrate circuitry. The least-mean-square (LMS) equalization method may be used to optimize DFE and minimise the error function. The eye metric may be used to adapt a multi variable CTLE by measuring the characteristics of the data “eye” at the receiver input. In ADC-based receivers, the input SNR may be measured at the slicing point (i e. just prior to slicing) and used as a metric for Calibration and/or Adaptation.

### SUMMARY

The present disclosure describes example circuits and systems that enable the use of Forward Error Correction (FEC) irk SerDes circuits to optimize system parameters.

As discussed in the Background section above, FEC has become recommended for mandatory for many high-speed SerDes applications in order to identify and correct errors in the received coded data stream. This error information detected by the FEC can be used as a figure of merit to optimize SerDes performance over a link.

According to some aspects, the present disclosure describes a system or device for optimizing system parameters of a serializer-deserializer (SerDes) using Forward Error Correction (FEC). The system comprise a receiver of the SerDes for receiving a data stream over a communication link, and a FEC module for identifying and correcting errors in the received data stream, wherein the FEC module generates error metadata indicating one or more characteristics of the errors present in the received data stream.

According to a further embodiment which can be combined with other embodiments disclosed herein, the present disclosure describes a method for optimizing system parameters of a serializer-deserializer (SerDes) using Forward Error Correction (FEC), comprising the steps of receiving a data stream over a communication link, and using a FEC to generate error metadata indicating one or more characteristics of the errors present in the received data stream.

According to a further embodiment which can be combined with other embodiments disclosed herein, the present disclosure describes a non-transitory computer-readable medium containing instructions enabling one or more processors of an electronic communication system to execute the steps of receiving a data stream over a communication link, and using a FEC to generate error metadata indicating one or more characteristics of the errors present in the received data stream,

According to a further aspect which can be combined with other embodiments disclosed herein, the error metadata comprises the bit error rate (BER) of the received data stream.

According to a further aspect which can be combined with other embodiments disclosed herein, the error metadata comprises metadata indicating one or more patterns in the types of errors present in the received data stream.

According to a further aspect which can be combined with other embodiments disclosed herein, the system or device further comprises a performance monitor module for receiving the error metadata from the FEC module and altering the value of one or more system parameters in response to the received error metadata.

According to a further aspect which can be combined with other embodiments disclosed herein, the performance monitor module is further configured to perform one or more optimization processes selected from the following list: SerDes Calibration, SerDes Adaptation, and Adaptive Voltage Scaling.

According to a further aspect which can be combined with other embodiments disclosed herein, the performance monitor module is configured to after the value of one or more system parameters in response to the received error metadata after performing the one or more optimization processes.

According to a further aspect which can be combined with other embodiments disclosed herein, the system parameters include one or more system parameters selected from the following list: receiver termination value, continuous time linear equalization, decision feedback equalization, various common mode voltage throughout receiver, voltage supply, voltage offset, bias current, continuous time linear equalizer frequency boost, sampling latch voltage offset, sampling time offset, sampling time mismatch between sampled channels, analog-to-digital converter accuracy, decision feedback equalizer tap values, or finite impulse response tap values.

According to a further aspect which can be combined with other embodiments disclosed herein, altering the value of one or more system parameters in response to the received error metadata comprises changing the value of one of the system parameters in a direction selected from the list of increasing or decreasing; monitoring the received error metadata to determine whether an error rate indicated by the error metadata has increased or decreased; continuing to change the value of the system parameter in the direction if the error rate has decreased; and changing the value of the system parameter in an opposite direction if the error rate has increased,

According to a further aspect which can be combined with other embodiments disclosed herein, altering the value of one or more system parameters in response to the received error metadata comprises changing the value of one of the system parameters in a direction selected from the list of increasing or decreasing; monitoring the received error metadata to determine whether an error rate indicated by the error metadata has increased or decreased; if the error rate has decreased, recording the error rate and the corresponding system parameter value; continuing to change the value of the system parameter in the direction until a maximum threshold error rate is indicated by the error metadata; and setting the system parameter to a value corresponding to a lowest recorded error rate.

According to a further aspect which can be combined with other embodiments disclosed herein, altering the value of one or more system parameters in response to the received error metadata comprises decreasing the value of a power consumption system parameter; monitoring the received error metadata to determine an error rate indicated by the error metadata; and continuing to decrease the power consumption system parameter until a target error rate is detected or a minimum power consumption system parameter value has been reached,

According to a further aspect which can be combined with other embodiments disclosed herein, the system or device further comprises a transmitter of the SerDes for transmitting the data stream over the communication link, and a backchannel for communicating error metadata from the receiver to the transmitter.

According to a further aspect which can be combined with other embodiments disclosed herein, the transmitter further comprises a performance monitor module for receiving the error metadata from the backchannel and altering the value of one or more system parameters in response to the received error metadata.

According to a further aspect which can be combined with other embodiments disclosed herein, the system parameters include one or more system parameters selected from the following list: transmitter termination value, voltage supply, bias current, finite impulse response tap values, transmitter clocking duty cycle distortion transmitter clocking integral non-linearity, and transmitter amplitude.

### BRIEF DESCRIPTION OF THE DRAWINGS

Reference will now be made, by way of example, to the accompanying drawings which show example embodiments of the present application, and in which:

FIG. 1 is a block diagram showing an example SerDes with FEC;

FIG. 2 is a block diagram showing the functional operation of a first example device capable of employing FEC to optimize a SerDes;

FIG. 3 is a graph of input BER and output BER in a SerDes utilizing FEC;

FIG. 4 is a flowchart showing a first example method for optimizing SerDes system parameters using FEC;

FIG. 5 is a graph of BER against a system parameter value during operation of the first example method of FIG. 4;

FIG. 6 is a flowchart showing a second example method for optimizing SerDes system parameters using FEC and avoiding local BER minima;

FIG. 7 is a graph of BER against a system parameter value during operation of the second example method of FIG. 6;

FIG. 8 is a flowchart showing a third example method for optimizing SerDes power optimization using FEC; and

FIG. 9 is a graph of BER against power supply voltage during operation of the third example method of FIG. 8.

Similar reference numerals may have been used in different figures to denote similar components.

### DESCRIPTION OF EXAMPLE EMBODIMENTS

The present disclosure describes example methods and systems that enable the use of Forward Error Correction (FEC) to optimize system parameters in a SerDes.

As described above in the Background section, SerDes Calibration and SerDes Adaptation attempt to optimize system parameters to preserve signal integrity. However, while maintaining signal integrity is the primary goal of optimizing system parameters, it is also desirable to minimize the use of power without losing signal integrity. Power consumption is therefore one of the system parameters that should be minimized when optimizing for signal integrity.

To this end, it is conceivable that similar adaptive voltage scaling (AVS) techniques used in large ASIC digital cores could be used for SerDes. AVS works by measuring PVT (process, voltage supply, temperature) to control the power supply to the circuit provided by internal (on board) or external (in package or on die) digitally programmable regulators.

AVS can generally only work at startup: it may only compensate process and fine tune the power supply for a given process corner. It can generally work in the background by tracking temperature. It may work based on a pre-determined lookup table, where Process and Temperature determine Voltage.

Thus, system parameters—including power consumption—can in theory be optimized by conducting Calibration, Adaptation, and AVS. The assumption underlying this approach is that the optimal system parameter settings converge on a single point where each of these three methods yields an optimal result independently.

However, this assumption is not necessarily warranted. The three methods of Calibration, Adaptation, and AVS as described above do not generate independent results in the system, and optimal system performance may exist at a point different from the convergence of the results of these three methods.

A potentially advantageous approach to system optimization may lie instead in optimizing with reference to the single most important quantity of the received signal; namely, the bit error rate (BER). Rather than relying on second-order indicators of signal quality, such as the output of PVT sensors, the characteristics of the data eye, and so on, it may be advantageous to instead optimize with the metric of minimizing the BER, which is a direct measure of signal integrity.

In the past, such a technique was out of reach, as any modulation or tuning of system parameters that increased BER above a very low threshold produced unacceptable errors in the received data stream that could not be recovered from. Indeed, without a FEC module in place, such errors could not even be detected.

However, as discussed in the Background section above, FEC has now become recommended or mandatory for many high-speed SerDes applications in order to identify and correct errors in the received coded data stream. This use of FEC in SerDes receivers introduces two major changes into the system with respect to the use of BER as a metric for optimization: first, errors in the received signal can now be detected by the FEC; and second, the FEC provides a margin whereby the BER level of the received data stream can be much higher than before without compromising system operation, as the FEC corrects the errors up to the level provided by its Coding Gain. In other words, the FEC allows the system to tolerate errors in the input data stream up to the threshold while preventing propagation of these errors in the FEC output data stream.

The first change allows the receiver to monitor the BER over time as system parameters are tuned. The second change permits the system to tune system parameters in a way that alters the BER at the receiver input without compromising the receiver's FEC output signal integrity. By combining these two new capabilities, the system can use the BER detected by the FEC as a metric for tuning and optimizing its system parameters. In theory, tuning the system parameters to minimize the BER of the received data stream may be able to identify the optimal system parameter settings for maintaining signal integrity and minimizing power consumption more effectively than the application of the Calibration, Adaptation, and AVS processes described above.

Optimizing on BER may be combined with one or more of the three optimization processes described. Calibration may be used to optimize circuit system parameters to reach a certain pre-determined set point for voltage and current. Adaptation may also be used to optimize filters to reach the lowest LMS error and/or achieve the largest data eye. AVS may also be used to adjust the power supply voltage vs. process and temperature based on a predetermined formula. However, without BER optimization, these three processes by themselves may result in a non optimal for BER, and especially with variation in voltage and temperature this can result in unacceptably high BER

A typical FEC module can correct a very high rate of error at its input, maintaining BER=0 at its output even with relatively high input BER (e.g., on the order of 1E-4 in the case of a KP4 FEC). This assumption holds true as long as the SerDes operates in a reasonable condition and therefore the error pattern is relatively random. However, if the SerDes operating conditions are compromised, due to non-optimal calibration or changes in the environment (e.g. in voltage or temperature), burst of errors can be generated that severely affect FEC Coding Gain. Furthermore, in current high speed links, severe loss and other channel impairments (e.g. low SNR due to PAM4 modulation, combined with large process/voltage/temperature variations) make it difficult even to maintain such a level of errors during operation. This runs the risk of “saturating” the FEC (i.e. producing a higher BER than the FEC can correct) and creating bit errors at its output.

Thus, to maintain the lowest possible BER at the FEC output, the BER at its input may be optimized as well so as to leave a margin for voltage and temperature variations during the course of operation. It is also important during operation to keep adaptation and calibration values at their optimum. Obtaining the lowest input BER to the FEC ensures the largest margin during link operation.

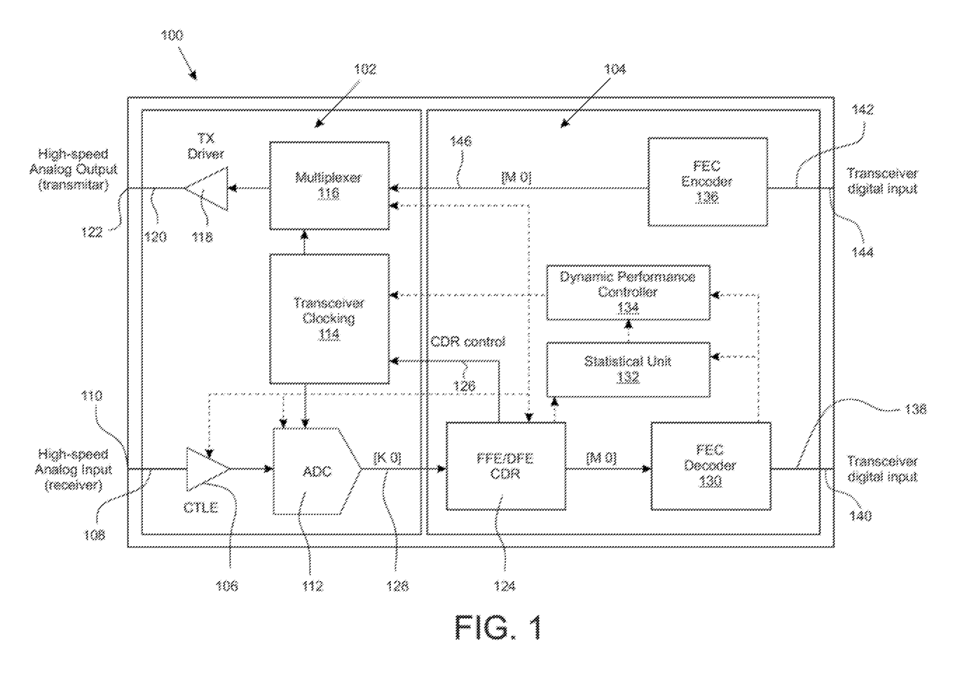

An example of a SerDes incorporating FEC capability is shown in FIG. 1. The SerDes 100 includes an analog portion 102 and a digital portion 104.

The analog portion 102 includes a continuous time linear equalizer (CTLE) 106 that receives a high-speed analog input 108 from a receiver 110. The CTLE 106 passes the equalized signal to an analog-digital converter (ADC) 112. A transceiver clocking module 114 passes a clock signal to the ADC 112 and a multiplexer 116. The multiplexer 116 receives a digital input signal 146 from the digital portion 104 of the SerDes 100 and sends the multiplexed signal as an output to a transmitter driver 118. The transmitter produces a high-speed analog output 120 for a transmitter 122.

The digital portion 104 includes a clock and data recovery circuit (CDR) 124 which receives the output 128 of the ADC, sends a CDR control signal 126 to the transceiver clocking module 114, and sends the recovered data signal to a forward error correction (FEC) decoder 130. The CDR block 124 acts as a digital signal processing (DSP) core and may include a feed-forward equalizer (FFE) and/or a decision feedback equalizer (DFE). The FEC decoder 130 generates a digital output signal 138 for a transceiver digital output 140. A statistical unit 132 receives control signals from the CDR 124 and FEC decoder 130, and it sends a control signal in turn to a dynamic performance controller 134. The dynamic performance controller 134 also receives control signals from the CDR 124 and FEC decoder 130, and it sends a control signal in turn to the transceiver clocking module 114. Finally, a FEC encoder 136 receives a digital input signal 142 from a transceiver digital input 144 and generates the digital input signal 146 for the multiplexer 116.

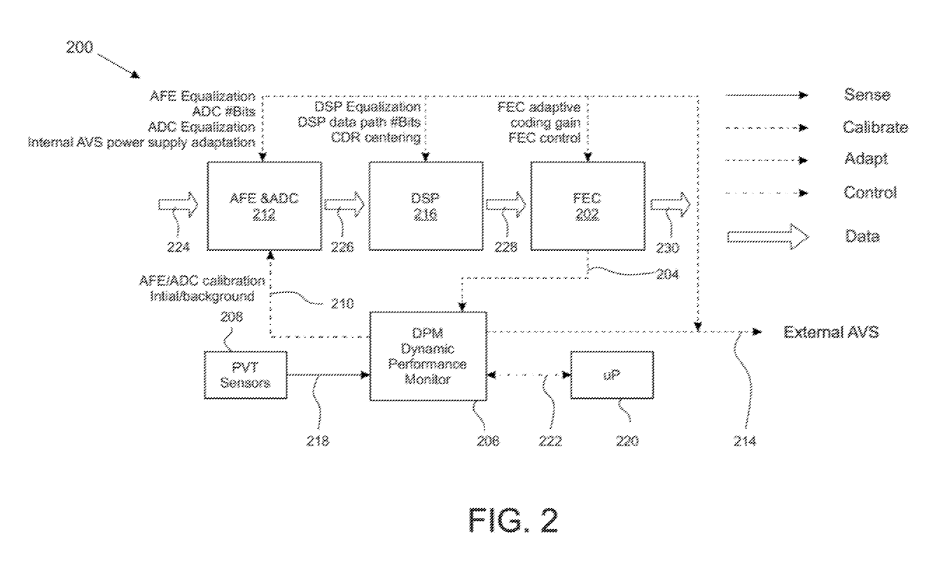

FIG. 2 shows an example embodiment of the present disclosure as a block diagram of a SerDes receiver 200 configured to apply FEC for the purpose of SerDes optimization.

This example receiver 200 is an ADC-based receiver having a large number of system parameters to optimize. In this example embodiment, the processing of data and control for the optimization process could be implemented in firmware, whereas in other embodiments it could be implemented in hardware or a combination of hardware and firmware.

Error metadata 204, such as BER statistics, is generated by the FEC 202 and collected by a dynamic performance monitoring (DPM) hardware unit 206. The DPM unit 206 also collects process/voltage/temperature (PVT) data 208 from PVT sensors 208. The DPM unit 206 is coupled to an embedded microprocessor 220 (run on firmware in this embodiment) by a bidirectional control link 222.

The microprocessor 220 is configured to run system parameter sweeps based on the error metadata 204. The DPM unit 206 then controls hardware system parameters accordingly. In the illustrated embodiment, the DPM unit 206 provides adaptation signals to an external AVS process 214, to the FEC 202, to a digital signal processing unit 216, and to an analog front-end (AFE)/ADC unit 212. The DPM 20$ also provides AFE/ADC calibration signals 210 to the AFE/ADC unit 212.

The adaptation signals sent to the AFE/ADC unit 212 may include AFE equalization, ADC number of bits, ADC equalization, and/or internal AVS power supply adaptation signals. The adaptation signals sent to the DSP unit 216 may include DSP equalization, DSQ data path number of bits, and/or CDR centering signals. The adaptation signals sent to the FEC 202 may include FEC adaptive coding gain and/or FEC control signals.

The calibration signals 210 sent to the AFE/ADC unit 212 may include AFE/ADC calibration and/or initial background signals.

The data stream through the receiver 200 is initially received as an input data signal 224 to the AFE/ADC unit. The AFE/ADC output data signal 226 passes to the DSP unit 216. The DSP output data signal 228 passes to the FEC 202, with BER hereinafter identified as iBER The FEC output data signal 230 has a BER hereinafter indicated as oBER,

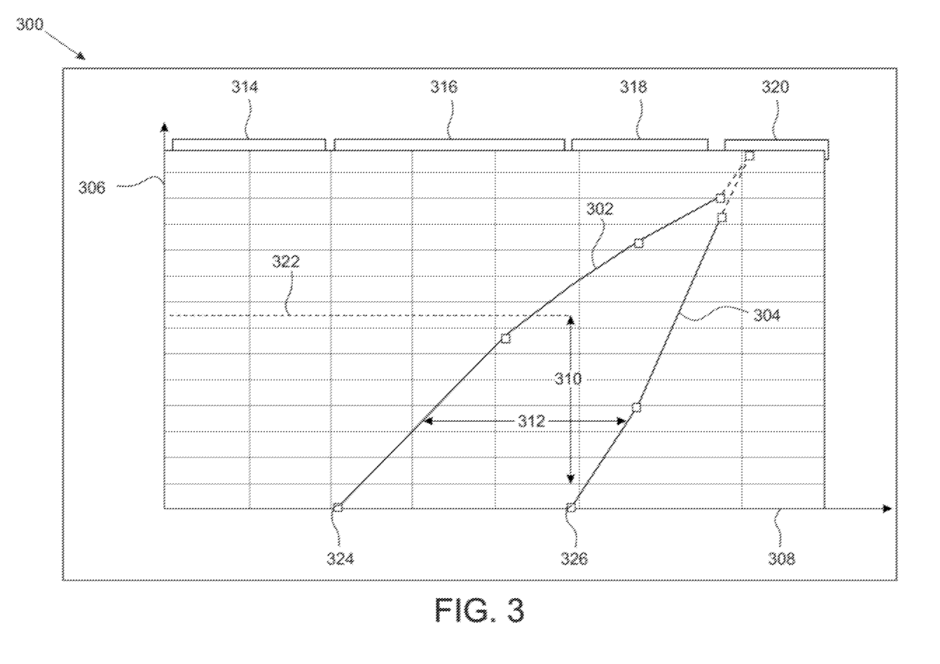

The relationship between FEC input BER (iBER), FEC output BER (oBER), and Coding Gain is shown in FIG. 3. A graph 300 of iBER 302 vs. oBER 304 is shown, with BER 306 as the vertical axis and insertion loss 308 (measured in decibels) as the horizontal axis. When insertion loss 308 is low, at the left side of the graph 300, the system resides in a first region 314 wherein iBER 302 is zero: the SerDes operates properly and error free. The FEC does not correct any errors, so actual FEC coding gain is effectively zero.

As insertion loss 308 increases, the SerDes operates properly but not error free, and errors are random and sparse in nature. iBER 302 increases above zero at point 324, the system enters a second region 316 wherein iBER 302 is greater than zero but the coding gain 310, 312 of the FEC is high enough to reduce oBER 304 below zero. (The coding gain is shown as measured in both BER 310 and insertion loss 312.) The FEC coding gain 310 is at its maximum value in this region 316.

However, as insertion loss 308 continues to increase and begins to saturate the FEC, the SerDes is no longer operating properly. Bursts of errors occur that are not random in nature. iBER 302 exceeds the coding gain 310 and oBER 304 increases above zero at point 326, taking the system into a third region 318 having a nonzero oBER 304. The FEC does not correct all errors, and the FEC coding gain 310 decreases.

Finally, as insertion loss 308 continues to increase, the system enters a fourth region 320 wherein the SerDes is not operating properly and loses its lock on the input data. Large burst of errors occur that saturate the FEC. The FEC overflows and decoding errors occur. The coding gain 310 of the FEC approaches 0 dB.

The system graphed in FIG. 3 may be taken to represent FEC applied in static nominal conditions at 28 Gbps and 4 mVrms integrated crosstalk noise (ICN).

FEC provides coding gain, and also provides information on errors detected (iBER) and errors corrected (oBER minus iBER, or effective coding gain). A number of specific methods may be employed by a suitable FEC-capable system to utilize BER as a metric for optimizing the SerDes. BER at the FEC input can be used as driving mechanism to further optimize results of Calibrations, Adaptations and AVS. Alternatively, this BER-based optimization may in some embodiments be used in the absence of one or more of Calibration, Adaptation and AVS.

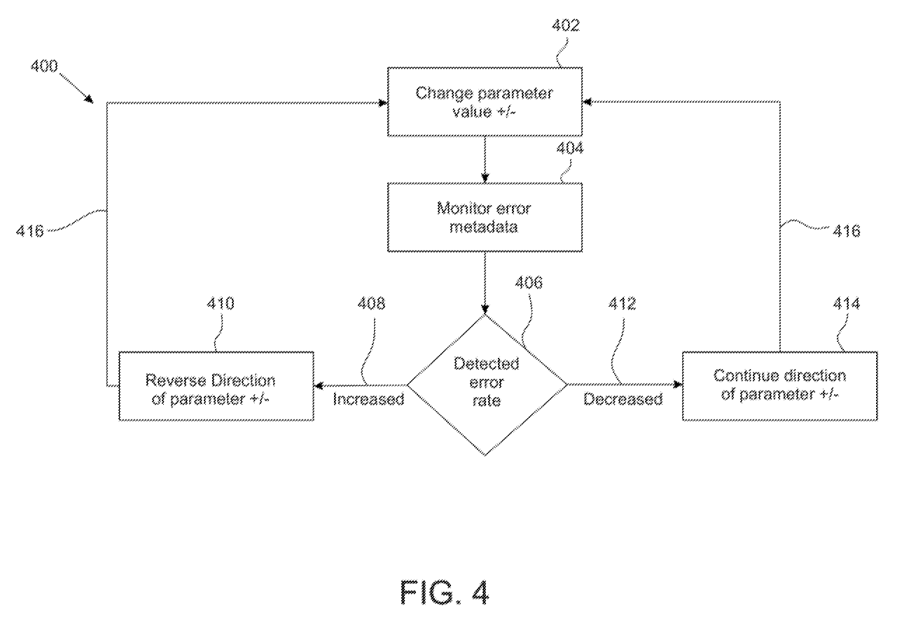

In a first example method of operation 400 shown in FIG. 4, a SerDes system parameter is optimized by tuning the system parameter value and responding to increases or decreases in BER to locate a BER minimum point. At step 402, the value of the chosen system parameter is changed in a given direction (i.e. increased or decreased). Where a system parameter indicates a bimodal or multi-modal value, such as “on” or “off”, each mode can be represented as a value, with switches between successive modes being equivalent to an increase or decrease in that system parameter's value.

At step 404, the error metadata generated as an output of the FEC is monitored. In this example embodiment, the error metadata includes an indication of an error rate, such as BER, of the FEC input signal. In other embodiments, the error metadata may include information about patterns in the errors and/or the types of errors detected at the FEC input.

At step 406, the error rate indicated by the error metadata is processed. If the error rate has decreased 412 in response to the system parameter change, the system continues to change the system parameter value in the current direction (i.e. increasing or decreasing) at step 414. If the error rate has increased 408 in response to the change in the system parameter value, the direction of system parameter value change is reversed at step 410. The system then returns 416 to the first step 402 to continue changing the system parameter value.

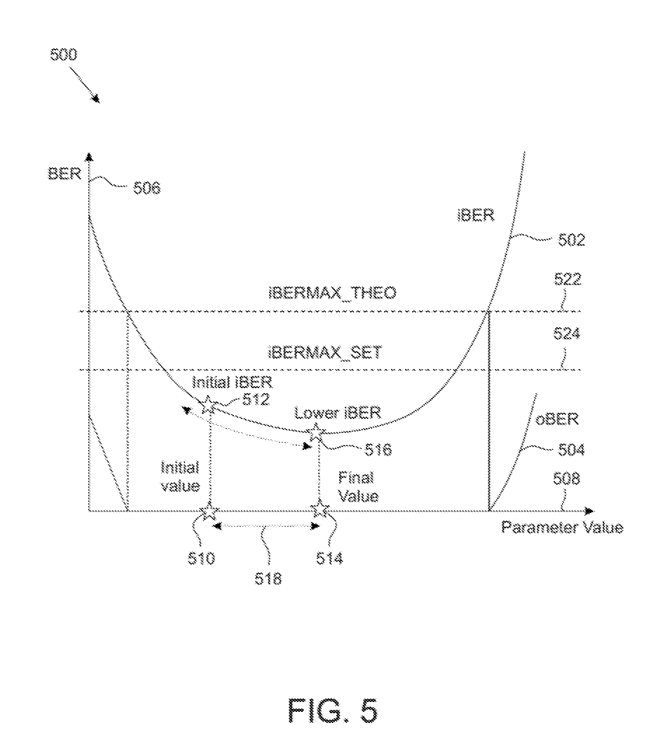

FIG. 5 shows a graph 500 of BER 506 as a system parameter value 508 is tuned according to the first example method 400. iBER 502 is the BER at the input of the FEC. oBER 504 is the BER at the output of the FEC. The theoretical iBER threshold 522 at which oBER 504 rises above zero acts as an absolute ceiling on iBER 502 during the tuning process. However, a lower threshold 524 for iBER 502 is set as an effective ceiling, providing a BER margin to account for design penalties. The method seeks to achieve a minimum iBER 502, and in any case an iBER 502 lower than the lower threshold 524, during optimization.

In operation, this method 400 seeks to improve and further optimize the Calibration, Adaptation and AVS convergence values by using iBER 502 as a figure of merit. The value of each system parameter 508 can be increased and decreased in order to evaluate its effect on iBER 502. If iBER 502 decreases, the direction of system parameter change (increasing/decreasing) is continued; if not, the direction is reversed.

During this process, iBER 502 will increase and decrease within a certain range. As long as iBER 502 is kept lower than the lower threshold 524, oBER 504 will remain at zero, guaranteeing proper, error-free link operation.

By operation of this process, an initial system parameter value 510 resulting in an initial iBER value 512 can be tuned up or down until a minimum iBER 516 is located, corresponding to a final system parameter value 514.

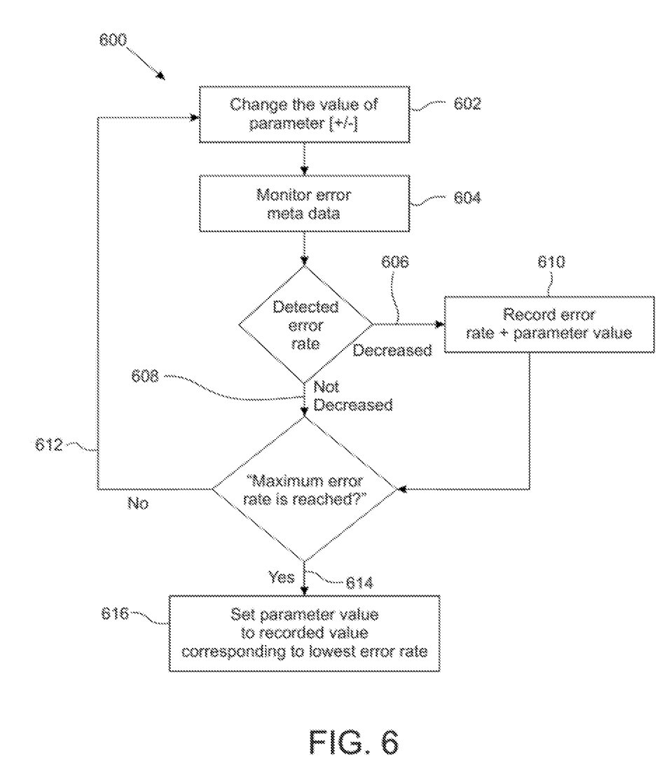

A second example method 600 for optimizing a FEC-capable SerDes using BER as a metric is shown in the flowchart in FIG. 6. This method 600 seeks to enhance the first example method of FIG. 4 by avoiding local minima in BER.

The first example method 400 of FIG. 4 may not yield the lowest iBER in all cases, as the system parameter value being tuned may get stuck in local minimum. Thus, in this second example method 600 the tuning of the system parameter value scans as far as possible from the initial value of the system parameter under optimization without reversing direction upon finding a local minimum. This second method 600 attempts to scan the entire range of system parameter values wherein iBER does not exceed a ceiling threshold. It then picks the system parameter value corresponding to the absolute minimum iBER within the range of scanned values.

The second example method 600 begins by changing the value of the system parameter being optimized 602 in a particular direction (up/down), as in the first method 400. The error metadata is monitored 604, again as in the first method 400. If the detected error rate decreases 606, the error rate and corresponding system parameter value are recorded 610, and then the method proceeds to continue changing the system parameter value in the current direction 612. If the detected error rate does not decrease 608, the step of recording 610 is bypassed.

At this stage, if a maximum allowable error rate is reached 614, the system sets the system parameter value to the recorded value corresponding to the lowest recorded error rate 616 from step 610. If the maximum allowable error rate has not been reached 612, the system returns to step 602 to continue changing the value of the system parameter.

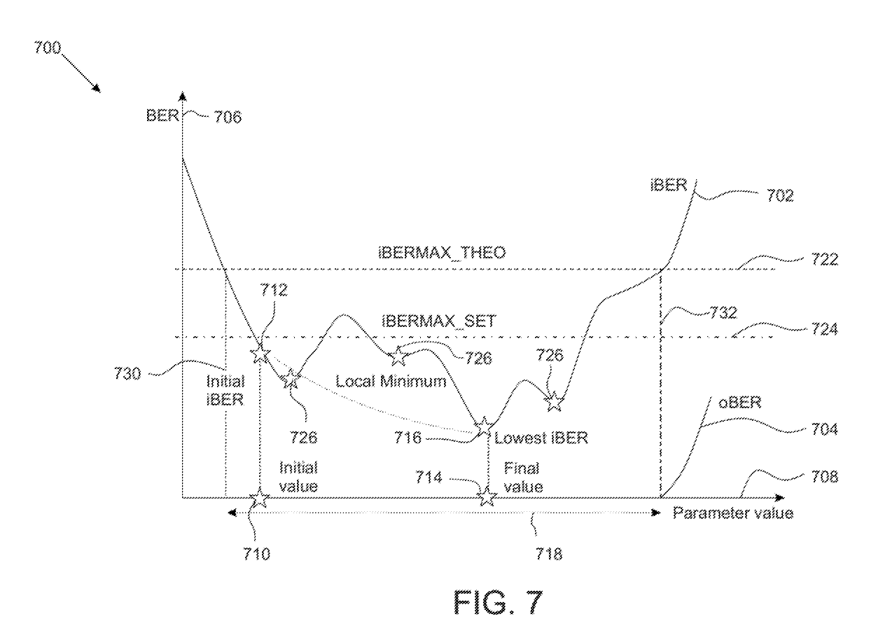

FIG. 7 shows a graph 700 of BER 706 as a system parameter value 508 is tuned according to the second example method 600 of FIG. 4 described above. iBER 702 is monitored as in first method 400. The theoretical iBER threshold 722 at which oBER 704 rises above zero acts as an absolute ceiling on iBER 702 during the tuning process. However, a lower threshold 724 for iBER 702 is set as an effective ceiling, providing a BER margin to account for design penalties. The method seeks to achieve a minimum iBER 702, and in any case an iBER 702 lower than the lower threshold 724, during optimization.

In contrast to first method 400, this second method 600 scans the entire range 718 of system parameter values 708 that correspond to iBER 702 lower than the absolute iBER threshold 722. If, during the scan, conditions change and the search becomes stuck in a local minimum iBER 726, the method 600 may exceed the lower iBER threshold 724 for a brief amount of time in order to come back to an absolute minimum 716, as long as iBER 702 remains below the absolute threshold 722.

In operation, the system parameter value 708 may begin at an initial value 710 corresponding to an initial iBER value 712. The scanning may be performed in different order in various embodiments, but one example embodiments may scan by first decreasing the system parameter value 708 from the initial value 710 until a point 730 where iBER 702 reaches the absolute iBER threshold 722. The value is then reset to the initial value 710 and scanned upward until it reaches another point 732 where iBER 702 reaches the absolute iBER threshold 722.

At the end of this scanning, which covers the entire range 718 between points 730, 732 where iBER 702 equals the absolute iBER threshold 722, the absolute minimum iBER 716 within that range 718 is identified from the recorded minima, and the system parameter value 308 is set to the corresponding value 714.

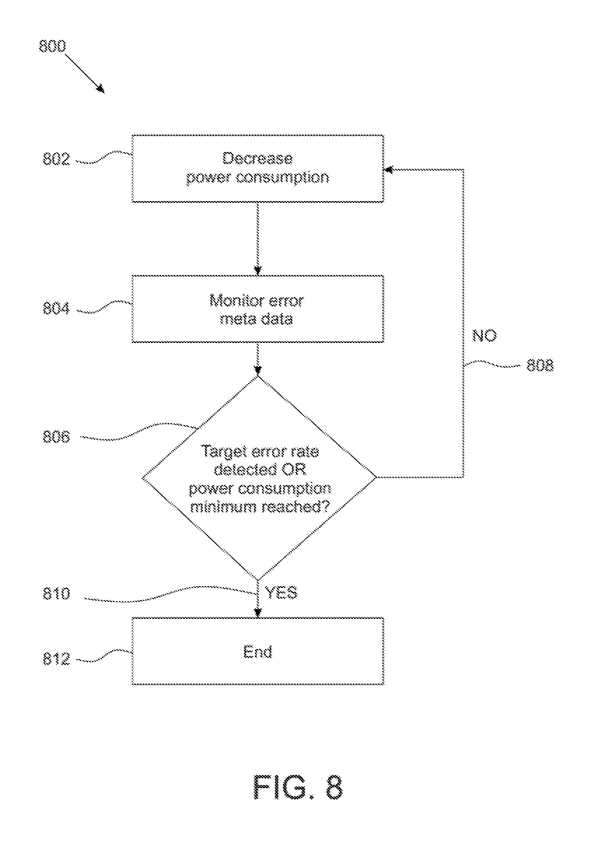

A third example method 800 is shown in the flowchart in FIG. 8. This method 800 seeks to minimize power consumption of the SerDes as part of the optimization procedure.

The power supply voltage is determined by scanning downward (i.e. decreasing) in a similar fashion as the various other system parameters as described above, with the process ending when BER reaches a threshold or power supply voltage reaches a low threshold.

In some embodiments, the power supply initial condition is set by a traditional AVS method. The method for reducing power consumption 800 then begins by decreasing power consumption 802 (e.g. decreasing power supply set point). The error metadata is monitored 80 as in previous methods 400, 600. As the power consumption is swept downward, the system monitors for a two-fold condition 806: is a target error rate is detected, or if power supply voltage reaches a minimum allowed point 810, then the process ends and the power consumption setting is not decreased further 812. If neither of these conditions 806 is met, then the downward sweep continues 808.

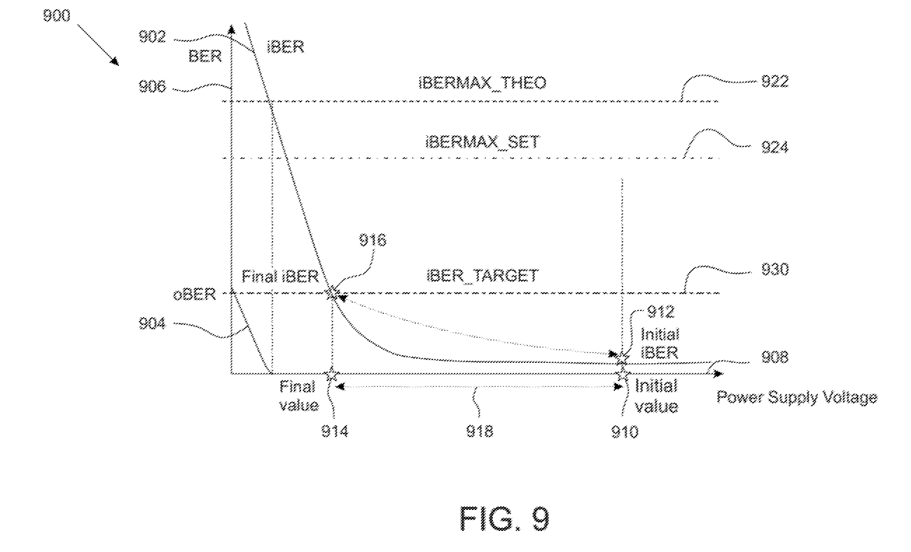

FIG. 9 is a graph 900 of BER 906 as power supply voltage 908 is decreased according to the third example method 800. iBER 902 is monitored as in first method 400. The theoretical iBER threshold 922 at which oBER 904 rises above zero acts as an absolute ceiling on iBER 902 during the tuning process. A lower threshold 924 for iBER 902 is set as an effective ceiling. However, a target iBER 930 is the most relevant threshold for this method 800.

The power supply voltage 908 begins at an initial value 910, possibly as a result of an AVS process. This yields an initial iBER value 912. At each step, the power supply voltage 908 (i.e. power consumption) is decreased, until a final power supply voltage value 914 is reached where iBER is at the iBER target 930. This results in a final power supply voltage level 914 and a final iBER value 916. The downward sweep of power supply voltage 908 spans the range 918.

The target error rate may be defined differently in various embodiments, but it generally is set at a level that ensures an oBER of zero within a set margin.

In different embodiments, the power supply may be an external regulator (DC-DC on the system board) or an internal regulator (LDO on chip).

Where it is an external regulator the voltage may be global (i.e. it applies to all SerDes lanes in an integrated circuit), and power may be decreased until the first SerDes lane reaches the target error rate.

Where it is an internal regulator, the voltage may be local (i.e. several regulators for each SerDes lane), and power may be decreased independently for each regulator until the target error rate is reached on a given lane.

Further example methods are possible that use error metadata generated by the FEC module to optimize SerDes system parameters. In some embodiments, the FEC may generate error metadata other than a simple scalar BER value. For example, the FEC or a related optimization or monitoring module may detect patterns in the errors being detected, such as periodic bursts of one-to-zero or zero-to-one errors in a PAM2-modulated system. Some embodiments may be able to adjust specific system parameter values by specific amounts in response to such specific error patters if the patterns correspond to known problems with known system parameter-based solutions.

One example of such an embodiment optimizing specific system parameters in response to detected patterns in the error metadata is the adjustment of the DFE (decision feedback equalization) coefficient in response to a detected burst of errors. When a burst of bit errors occur, it is likely that the DFE coefficient is too high, causing error propagation to happen. A known solution would be to limit the DFE coefficient value in the adaptation by limiting the growth of the coefficient, or even to reduce the value of the coefficient via a corresponding increase of the contribution of CTLE (continuous time linear equalizer) equalization.

The SerDes system parameters optimized using these and other example methods may include any controllable system parameter affecting SerDes operation. A partial list of such system parameters includes: receiver termination value, transmitter termination value, continuous time linear equalization, decision feedback equalization, common mode, voltage supply, voltage offset, bias current, continuous time linear equalizer frequency boost, other transfer function system parameters (BW, squelch, etc.), sampling latch voltage offset, sampling time offset, sampling time mismatch between sampled channels, analog-to-digital converter accuracy (for ADC-based receivers), gain and mismatch (for interleaved ADC-based receivers), decision feedback equalizer tap values, finite impulse response tap values, transmitter clocking duty cycle distortion, transmitter clocking integral non-linearity, and transmitter amplitude.

In some embodiments of these methods, they may be applied sequentially to a series of system parameters. In other embodiments, the tuning of each system parameter may be carried out in parallel, or each system parameter may be partially tuned in sequence followed by subsequent partial tuning passes over each system parameter.

Some system parameters may affect both transmitter and receiver performance. Generally, however, iBER 502 is only monitored at the receiver end. Thus, in embodiments that seek to tune transmitter-related system parameters, a backchannel or other communication link from the receiver side to the transmitter side of the SerDes may be provided, thereby enabling communication of the iBER 502 and/or other error metadata detected by the receiver-side FEC to the transmitter side. Having this information at the transmitter side allows transmitter-related system parameters to be tuned according to the various example methods set out in this disclosure.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., an embedded processor, a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A serializer-deserializer (SerDes) integrated circuit (IC) using Forward Error Correction (FEC), the circuit comprising:
a receiver of the SerDes for receiving a data stream over a communication link; and
a FEC module for identifying and correcting errors in the received data stream, and for generating error metadata indicating one or more characteristics of the errors present in the received data stream.

2. The IC of claim 1, wherein the error metadata comprises the bit error rate (BER) of the received data stream.

3. The IC of claim 1, wherein the error metadata comprises metadata indicating one or more patterns in the types of errors present in the received data stream.

4. The IC of claim 1, further comprising:
a performance monitor module for receiving the error metadata from the FEC module and altering the value of one or more system parameters in response to the received error metadata.

5. The IC of claim 4, wherein the performance monitor module is further configured to perform one or more optimization processes selected from the following list: SerDes Calibration, SerDes Adaptation, and Adaptive Voltage Scaling.

6. The IC of claim 5, wherein the performance monitor module is configured to alter the value of one or more system parameters in response to the received error metadata after performing the one or more optimization processes.

7. The IC of claim 4, wherein the system parameters include one or more system parameters selected from the following list: receiver termination value, continuous time linear equalization, decision feedback equalization, common mode, voltage supply, voltage offset, bias current, continuous time linear equalizer frequency boost, sampling latch voltage offset, sampling time offset, sampling time mismatch between sampled channels, analog-to-digital converter accuracy, decision feedback equalizer tap values, and finite impulse response tap values.

8. The IC of claim 4, wherein altering the value of one or more system parameters in response to the received error metadata comprises:
changing the value of one of the system parameters in a direction selected from the list of increasing or decreasing;
monitoring the received error metadata to determine whether an error rate indicated by the error metadata has increased or decreased;
continuing to change the value of the system parameter in the direction if the error rate has decreased; and
changing the value of the system parameter in an opposite direction if the error rate has increased.

9. The IC of claim 4, wherein altering the value of one or more system parameters in response to the received error metadata comprises:
changing the value of one of the system parameters in a direction selected from the list of increasing or decreasing;
monitoring the received error metadata to determine whether an error rate indicated by the error metadata has increased or decreased;
if the error rate has decreased, recording the error rate and the corresponding system parameter value;
continuing to change the value of the system parameter in the direction until a maximum threshold error rate is indicated by the error metadata; and
setting the system parameter to value corresponding to a lowest recorded error rate.

10. The IC of claim 4, wherein altering the value of one or more system parameters in response to the received error metadata comprises:
decreasing the value of a power consumption system parameter;
monitoring the received error metadata to determine an error rate indicated by the error metadata; and
continuing to decrease the power consumption system parameter until a target error rate is detected or a minimum power consumption system parameter value has been reached.

11. The IC of claim 1, further comprising:
a transmitter of the SerDes for transmitting the data stream over the communication link; and
a backchannel for communicating error metadata from the receiver to the transmitter.

12. The IC of claim 11, wherein the transmitter further comprises a performance monitor module for receiving the error metadata from the backchannel and altering the value of one or more system parameters in response to the received error metadata.

13. The IC of claim 12, wherein the system parameters include one or more system parameters selected from the following list: transmitter termination value, voltage supply, bias current, finite Impulse response tap values, transmitter clocking duty cycle distortion, transmitter clocking integral non-linearity, and transmitter amplitude.

14. A method for optimizing system parameters of a serializer-deserializer (SerDes) using Forward Error Correction (FEC), comprising the steps of:
receiving a data stream over a communication link; and
using a FEC to generate error metadata indicating one or more characteristics of the errors present in the received data stream.

15. The method of claim 14, further comprising the step of:
altering the value of one or more SerDes system parameters in response to the error metadata.

16. The method of claim 15, wherein altering the value of one or more system parameters in response to the received error metadata comprises the steps of:
changing the value of one of the system parameters in a direction selected from the list of increasing or decreasing;
monitoring the received error metadata to determine whether an error rate indicated by the error metadata has increased or decreased;
continuing to change the value of the system parameter in the direction if the error rate has decreased; and
changing the value of the system parameter in an opposite direction if the error rate has increased.

17. The method of claim 15, wherein altering the value of one or more system parameters in response to the received error metadata comprises the steps of:
changing the value of one of the system parameters in a direction selected from the list of increasing or decreasing;
monitoring the received error metadata to determine whether an error rate indicated by the error metadata has increased or decreased;
if the error rate has decreased, recording the error rate and the corresponding system parameter value;
continuing to change the value of the system parameter in the direction until a maximum threshold error rate is indicated by the error metadata; and
setting the system parameter to a value corresponding to a lowest recorded error rate.

18. The method of claim 15, wherein altering the value of one or more system parameters in response to the received error metadata comprises the steps of:
decreasing the value of a power consumption system parameter;
monitoring the received error metadata to determine an error rate indicated by the error metadata; and
continuing to decrease the power consumption system parameter until a target error rate is detected or a minimum power consumption system parameter value has been reached.

19. The method of claim 14, further comprising the step of:
communicating the error metadata from a SerDes receiver o a SerDes transmitter over a backchannel.

20. A serializer-deserializer (SerDes) integrated circuit (IC) using Forward Error Correction (FEC), the circuit comprising:
a receiver of the SerDes for receiving a data stream over a communication link;
a FEC module for identifying and correcting errors in the received data stream, and for generating error metadata indicating one or more characteristics of the errors present in the received data stream;
at least one power/voltage/process (PVT) sensor for generating PVT data;
a microprocessor configured to vary system parameters; and
a dynamic performance module (DPM) configured to:
collect the error metadata and PVT data;
direct the microprocessor to vary system parameter values;
monitor the correspondence between the error metadata and the values of the system parameters being varied by the microprocessor; and
set values for the system parameters based on the observed correspondence between the error metadata and the system parameter values.

21. The circuit of claim 20, further comprising an analog front-end (AFE)/analog-digital converter (ADC) unit and a digital signal processor (DSP), wherein:
the DPM setting values for the system parameters comprises:
sending adaptation signals to the AFE/ADC unit, the DSP, the FEC, and an external adaptive voltage scaling (AVS) process; and
sending AFE/ADC calibration signals to the AFE/ADC unit.
